(19) United States
(12) Patent Application Publication
(10) Pub. No.: US 2015/0048187 A1
(43) Pub. Date: Feb. 19, 2015

(54) Slag Breaker

(71) Applicant: TARTECH eco industries AG, Berlin (DE)

(72) Inventor: Claus Gronholz, Ammersbek (DE)

(21) Appl. No.: 14/457,459

(22) Filed: Aug. 12, 2014

(30) Foreign Application Priority Data
Aug. 13, 2013 (EP) 13180206.8

(51) Int. Cl. B02C 13/14; B02C 13/28; B02C 13/286

(52) U.S. Cl. CPC B02C 13/14; B02C 13/286; B02C 13/28; B02C 2013/2869; B02C 2013/2808
USPC 241/27; 241/188.1

(57) ABSTRACT

A device for the mechanical processing of slags by impact elements within a processing chamber includes a housing having a filling opening and a discharge opening in which at least one rotor with impact elements rotating about an axle is placed. The slags pass through the rotor on the way from the filling opening to the discharge opening and the rotor is configured in such a way that it has a processing density of at least 90% of the slags of a slag flow that has been fed.

### CROSS-REFERENCE TO RELATED APPLICATIONS

This application claims the benefit and priority of European Application No. 13180206.8, filed Aug. 13, 2013. The entire disclosure of the above application is incorporated herein by reference.

### FIELD

This invention relates to a slag breaker. This being, the matter is of devices for the mechanical processing of slags by means of impact elements.

### BACKGROUND

Slags in the sense of this invention are conglomerates of materials of different density as well as possibly of different consistency. Slags are known to be generated in the ore processing or also as combustion residues. Slags are generated in particular in connection with waste recycling within the scope of waste incineration. However, slags in the sense of this invention are also landfill materials of different type and other conglomerates of the mentioned type. Such slags generally consist, for example, of earth, sand, stones and inclusions of all types, thus of ferrous and non-ferrous metals, light metals, precious metals and the like. Slags are known to be mechanically broken or opened up by simply crushing them with hammer mills or impact mills.

It is also known, for example, from PCT/EP/2012/001603 to process the slags in breaking chambers with impact tools, whereby the matter is of impact tools fixed to supports rotating about axles. The slags are guided from a feed opening into the rotating area of the rotors. They are then hit by the impact elements and broken open. The earth components that are, depending on their origin, compacted, almost sintered or even compressed like ceramic materials are being separated from the compacted metal components. Depending on different parameters such as drop height, speed of the impact tools or the impact elements or the like, the slags are then broken open into corresponding grain sizes.

Thus, a device for the mechanical processing of slags by means of impact elements is known, with a processing chamber configured with a housing having a filling opening and a discharge opening. At least one rotor is arranged in the processing chamber. Depending on the embodiment, at least two rotors rotating about one axle with impact elements are arranged. One of these two rotors is a leading rotor with respect to the slag flow, the other one behind this one is configured as a trailing rotor, this being considered in direction of the slag flow. The slag flow passes through the rotors on the way from the filling opening to the discharge opening. Usually the slags move gravitationally, i.e. the proper processing position of such devices is such that a filling opening is in an upper position, this being considered vertically. Slags are filled into this opening. The driving axle is generally vertical so that the rotor planes extend horizontally, i.e. perpendicularly thereto. The slags filled from above thus fall through the processing chamber downwards and pass through the different rotor planes. They are processed accordingly, i.e. they are at least partially brought into contact with the impact elements of the rotors. After the last rotor, the slags fall into the area of the discharge opening situated below.

Meanwhile, there is a need for a quick and efficient processing to process the slags, starting from pre-sieved grain sizes to most homogeneous grain sizes, whereby the target grain sizes can also have the smallest dimensions up to the μ-range.

The previously known device with successive widening rotor rotation planes has the disadvantage of undefined or controlled processing densities of the slag flows.

In the sense of this invention, processing density is understood as the quantity of a slag flow fed to a rotor by means of the impact elements guided by this rotor. Independently from the fact that a slag flow is fed by a filling opening, a feeding channel or by a leading rotor, a slag flow reaches the rotor plane and has to pass through this plane. This being, it is obvious that, depending on the conditions and on the construction, not all the parts of the slag flow that pass through the rotor plane are hit and thus processed by the impact elements of the rotor.

This has the disadvantage that slag flows that are possibly guided through a processing chamber have to be fed again to the chamber and that on the whole the throughput is limited.

### SUMMARY

Starting from the state of the art described above, the aim of this invention is to provide a device for the mechanical processing of slags by means of impact elements that has an improved efficiency.

A device with the characteristics of the present disclosure is indicated for the technical solution of this aim. Further advantages and characteristics result from the subclaims. The invention also protects a method with the characteristics of the present disclosure.

According to the invention, several filling openings that are placed in different planes of the housing are provided. This means in particular that the different filling openings are spaced from each other in vertical direction. Additionally, the filling openings can also be spaced from each other in horizontal direction. The matter is for the filling openings of channels that are in particular constructionally separated from each other. Each filling opening can form a channel separated from the other filling openings.

An effect of the filling openings in different planes of the housing consists in that different speeds can be achieved with respect to slags hitting a rotor plane or an impact element. In addition or as an alternative, it can also be provided that slag parts with different properties, for example with respect to mass and/or shape, are fed by the different filling openings. However, it can be achieved by a combination of drop height on the one hand and properties of the slag components on the other hand that slag components with different properties reach the different rotor planes or the impact elements with approximately the same speed.

The device according to the invention and the method according to the invention thus allow improving the result of the slag components processing by the impact elements so that there results a clearly increased processing density with respect to the state of the art. Due to the configuration according to the invention, it can be of more than 90%.

The rotor can also be configured in such a manner that it has a processing density of at least 90% of the slags of the slag flow that has been fed. Thus, approximately 90% of the conglomerate components that constitute the slag flow are hit by the impact elements of the rotor, processed and thus broken up.

The purpose of the processing device consists in the introduction of slags of a certain grain size into the filling opening. Slags with a correspondingly smaller grain size or conglomerates of materials of a correspondingly broken size are then obtained at the discharge opening. These ratios can principally be defined for each single rotor plane. It is thus possible to check the slag flow after passing a rotor to state to which extent the slag flow fed to the rotor has been processed. A grain distribution can here inform on whether the desired processing density has been achieved.

When a slag flow is introduced in a corresponding processing chamber in a filling opening, it first passes the first rotor plane and is then partially broken up. The slag flow has preferably been pre-sieved and covers a previously known size range. Since the drop height to the rotor plane is known as well as the fall speed, a certain processing density of the slag flow can be evaluated. It has been stated with the invention that, depending on the size of the impact elements, on the number of the impact elements and of the rotation speed and taking into account the other previously known parameters such as feeding speed (V_{Z}), grain size, drop height and slag volume and the like, the processing density can be evaluated or influenced. According to the invention, the inflow speed (V_{E}) can be controlled herewith.

According to the invention, a rotor is configured with a corresponding number of impact elements for the processing of a given grain size that is guided into the rotor plane at a previously known height. According to the invention, the impact elements can be configured in the length and in the width with respect to the rotor plane. But they can also be dimensioned with respect to their height, i.e. substantially in direction of the slag flow. Since the impact elements rotate about the axle, an optimal processing takes place when an impact element hits slags with its side wall defined by the height. Knowing the slag flow and the number of the rotating impact elements as well as the height thereof, a hit probability that can be used as a measure for the processing density can be indicated. The device itself must be designed in such a manner that it allows the rotor speed corresponding to the processing density. This being, single rotors or rotor groups can be placed on a driving axle. The impact elements are usually impactors that are fixed by means of chain links to the rotor axle. According to the invention, they have beveled side edges. In this way, the slags that have been hit still receive a guiding pulse and can, for example, be conveyed again into the area above the rotor plane, which also increases the processing density.

According to the invention, successive rotor groups can also have driving axles independent from each other and can thus be operated in different ways.

The device according to the invention is an embodiment of the method according to the invention that makes possible correspondingly high processing densities due to the design of the rotor plane.

### DRAWINGS

Further advantages and characteristics of the invention result from the following description with reference to the figures.

FIG. 1 shows a partial sectional view of an embodiment of a slag breaker according to the invention.

FIG. 2 shows a detailed view in the area of a rotor.

FIG. 3 shows a detailed view of an embodiment of an impact element.

### DETAILED DESCRIPTION

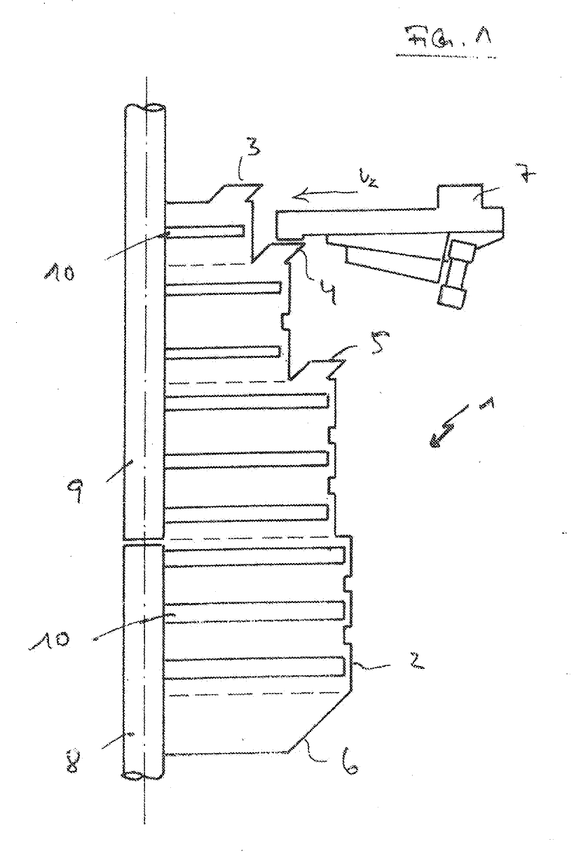

According to FIG. 1, a processing device or a slag breaker 1 comprises a housing 2. In the embodiment that is shown, the housing 2 has filling openings 3, 4, 5. They can be closed by covers that are not shown. A discharge opening is configured in the lower area.

In the embodiment that is shown, a transport device for slags is shown in the area of the inlet opening 4 with which the slag flow can be dimensioned or controlled.

Driving axles 8, 9 to which rotor elements 10 are fixed are shown in the vertical center of the housing 2. These axles are shown in the embodiment shown as paddles but can also be impactors and the like fixed to chains.

A slag breaker 1 functions in such a manner that slags are filled into one or several filling openings 3, 4, and 5. These slags pass then through different rotor planes and are processed correspondingly by the rotors, whereby slag parts are hit by the impact elements by being scattered or broken up. Due to the forces prevailing in the housing, the slags are transported outwards and further processed in the respectively next rotor planes.

The embodiment shown in FIG. 1 now allows filling the housing over different planes 3, 4, 5. Depending on the aim to be achieved, the housing can, for example, be filled only by the opening 5 so that only the lower both rotor groups are active. But it is also possible to fill over all the filling openings in order to produce either a corresponding slag flow or, for example, to feed different grain sizes by the different openings. The respectively biggest grain size is fed by the filling opening 3, then by 4 and 5 for respectively smaller grain sizes.

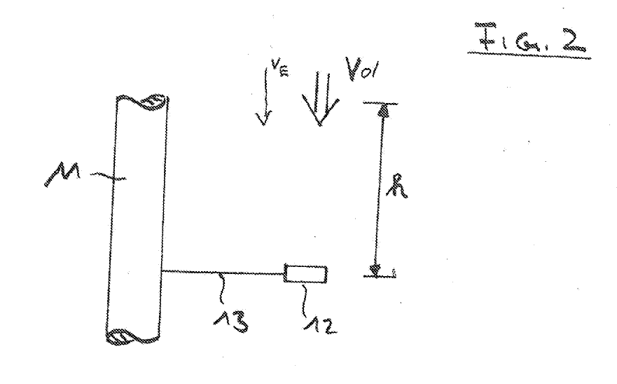

FIG. 2 schematically shows a part of a driving axle 11. An impact element 12 is fixed to the driving axle 11 by means of a connecting element 13 so that, when the driving axle 11 rotates, the impact element defines a rotor plane. A slag flow with the volume Vol falls into the rotor plane defined by the impact element 1 over a drop height h either by a filling opening or coming from a leading rotor. Depending on the number of impact elements placed in the rotor plane, of their size and of the speed with which the driving axle 11 rotates, there results the level of processing density. As far as the grain size of the slags in the volume flow is known, there results from the drop height h and the mentioned parameters the probability with which a proportion of slags is hit by the impact element 12.

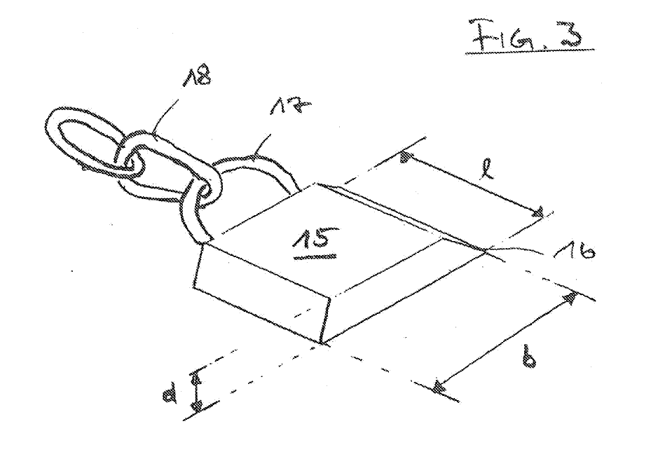

FIG. 3 shows in detail the impact element 15 with the beveled lateral edge 16. A fastening lug 17 serves for fixing chain links 18 to a driving axle (that is not shown) around the impact element in this way. When the driving axle rotates, the impact element 15 flies in a plane around the center. The length I of the impact element 15, the width b as well as the thickness d are variable. These parameters in connection with the grain size, the volume flow Vol as well as the drop height h are the parameters for controlling the processing density.

The embodiment that has been described is only for describing purposes and is not restrictive.

What is claimed is:

1. A device for the mechanical processing of slags, comprising:
a housing including a processing chamber, a filling opening and a discharge opening; and
at least one rotor including impact elements rotating about an axle, the rotor being positioned within the processing chamber such that the slags pass through the rotor on the way from the filling opening to the discharge opening, wherein several filling openings are provided that are placed in different planes of the housing.

2. The device according to claim 1, wherein at least one leading and one trailing rotor are placed in the processing chamber as rotors rotating about an axle with impact elements through which the slags pass on the way from the filling opening to the discharge opening, whereby the trailing rotor is configured in such a way that it has a processing density of at least 90% of the slags of a slag flow fed by the leading rotor.

3. The device according to claim 1, wherein the rotor has a number and size of impacts elements corresponding to the processing density.

4. The device according to claim 2, wherein the trailing rotor is positioned at a distance from the leading rotor that corresponds to the processing density.

5. The device according to claim 1, wherein a rotor speed corresponds to the processing density.

6. The device according to claim 1, wherein the impact elements have beveled side edges.

7. The device according to claim 1, wherein the impact elements are fixed to the rotor axle by means of chain links.

8. The device according to claim 1, wherein at least two rotors are placed on a common driving axle.

9. The device according to claim 1, wherein the dimensioning of the rotors and the rotational speed for the processing of slags of a predetermined grain size are fixed.

10. The device according to claim 1, further including several rotor groups following each other.

11. The device according to claim 10, wherein the rotor groups following each other have driving axles independent from each other.

12. The device according to claim 1, wherein the rotor is configured in such a manner that it has a processing density of at least 90% of the slags of a slag flow that has been fed.

13. The device according to claim 1, wherein the filling openings are spaced from each other in horizontal direction.

14. A method for the mechanical processing of slags, comprising:
providing impact elements in a processing chamber in a housing having a filling opening and a discharge opening;
providing at least one rotor with impact elements rotating about an axle;
passing the slags through the rotor on the way from the filling opening to the discharge opening, wherein slags are fed through several filling openings placed in different planes of the housing.

15. The method according to claim 14, wherein feeding devices are positioned over the filling openings with which depending on the number and shape of the impact elements as well as on the rotational speed and the respective grain size of the slags, an inflow speed (V_{E}) is controlled in such a manner that at least 90% of the slags of a slag flow fed by the leading rotor are processed.

16. The method according to claim 14, wherein at least 90% of the slags of a slag flow fed by the leading rotor are processed by the rotor.
